(19) United States
(12) Patent Application Publication
(10) Pub. No.: US 2008/0125198 A1
(43) Pub. Date: May 29, 2008

(54) PORTABLE MULTIMEDIA COMMUNICATION APPARATUS

(75) Inventor: Young S. KIM, Los Altos, CA (US)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/939,865

(22) Filed: Nov. 14, 2007

(30) Foreign Application Priority Data
Nov. 29, 2006 (KR) 10-2006-0118893

(51) Int. Cl. H04B 1/38; H04M 1/00

(52) U.S. Cl. 455/575.3; 455/550.1; 455/566

(57) ABSTRACT

A multimedia portable communication apparatus includes a first housing, a second housing including a display unit, a first hinge unit, and a third housing. The second housing is adapted to rotate in a transverse direction of the first housing to fold onto or unfold from the first housing. The first hinge unit is to rotatably connect the second housing to the first housing. The third housing includes a keyboard and is adapted to slide along a longitudinal direction of the first housing while facing the first housing and to rotate in the longitudinal direction so that the third housing folds or unfolds to be parallel to a longitudinal direction of the second housing.

### CROSS REFERENCE TO RELATED APPLICATION

This application claims priority from and the benefit of Korean Patent Application No. 10-2006-0118893, filed on Nov. 29, 2006, which is hereby incorporated by reference for all purposes as if fully set forth herein.

### BACKGROUND OF THE INVENTION

1. Field of the Invention

The present invention relates to a multimedia portable communication apparatus, such as a Digital Multimedia Broadcasting (DMB) phone, a game phone, a chatting phone, a camera phone, an MP3 phone, a cellular phone, a Personal Communication Service (PCS) phone, a Personal Digital Assistant (PDA), and a Hand Held Phone (HHP).

2. Discussion of the Background

As generally known in the art, the term “portable communication apparatus” refers to an electronic apparatus that a user can use to perform wireless communication with a desired partner. For example, wireless communication includes voice communication, message transmission, file transmission, video communication, and camera functions. A portable communication apparatus can also act as a secretary for its user, for example, it may manage telephone numbers and a personal schedule.

Considering the portability, designs of such portable communication apparatuses tend not only to be compact, slim, and light, but are also moving toward providing multimedia availability and a wider variety of functions, such as entertainment contents including games and amusements. Future portable communication apparatuses are expected to incorporate not only the basic voice communication function, but also greater multi-functionality and multi-purpose utilization, including functions regarding video communication, games, the Internet, and cameras.

Conventional portable communication terminals are classified as bar-type apparatuses and folder-type apparatuses according to their appearance, as well as their portability and user convenience. Folder-type portable communication apparatuses have a body and a folder rotatably coupled to the body by a hinge unit. Keys are arranged on the body while a display unit is positioned on the folder. This arrangement is advantageous to compactness and portability.

An example of a folder-type communication apparatus is disclosed in U.S. Pat. No. 6,865,406.

Portable communication apparatuses may also be classified as swing-type apparatuses and sliding-type apparatuses according to the manner in which they are opened and closed.

Examples of sliding-type and swing-type portable communication apparatuses are disclosed in detail in Korean Patent Application No. 2002-71911 and U.S. patent application Ser. No. 10/822,380, respectively.

However, while conventional portable communication apparatuses may not be overly inconvenient with regard to inputting data and checking displayed data in a phone mode for voice communication or text message transmission, the inconvenience is not negligible in multimedia-oriented environments.

This problem may be overcome by increasing the overall size of portable communication apparatuses so a wider display unit may be mounted and more keys may be included. However, this is contrary to the current trend toward compactness and better portability.

In summary, all types of conventional portable communication apparatuses may be limited in their abilities to accommodate wider display units, and their limited number of keys may make it difficult to input complicated data.

Furthermore, current users may be very concerned with the convenience of data input/output devices.

Particularly, users of portable communication apparatuses may expect the display units to be positioned in the horizontal direction, preferably at a convenient angle, so that they can watch moving images more conveniently.

Therefore, a portable communication apparatus having a data input/output device adapted for a new interfacing environment (e.g. portable Internet) is desirable.

### SUMMARY OF THE INVENTION

The present invention provides a portable communication apparatus that may be compact and convenient to carry.

The present invention also provides a portable communication apparatus that may provide for convenient use of portable Internet.

The present invention also provides a portable communication apparatus that may provide for convenient use in a QWERTY mode.

The present invention also provides a portable communication apparatus having a wide display unit so that the displayed screen may be watched conveniently.

The present invention also provides a portable communication apparatus that enables a user to input data using both hands and includes a display unit that may be positioned in the horizontal direction at an angle so as to improve the user interface environment related to data input/output.

Additional features of the invention will be set forth in the description which follows, and in part will be apparent from the description, or may be learned by practice of the invention.

The present invention discloses a multimedia portable communication apparatus including a first housing, a second housing, a first hinge unit, and a third housing. The second housing includes a display unit and is adapted to rotate in a transverse direction of the first housing so as to fold onto or unfold from the first housing. The first hinge unit is to rotatably connect the second housing to the first housing. The third housing includes a keyboard and is adapted to slide along a longitudinal direction of the first housing while facing the first housing and to rotate in the longitudinal direction so that the third housing folds or unfolds to be parallel to a longitudinal direction of the second housing.

The present invention also discloses a multimedia portable communication apparatus including a housing, a display unit, a first hinge unit, and a folding-type keyboard. The display unit is adapted to rotate in a transverse direction so as to fold onto or unfold from the housing. The first hinge unit is to rotatably connect the display unit to the housing and the folding-type keyboard is adapted to slide in a longitudinal direction while facing the housing so that the keyboard is parallel to the display unit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view of a multimedia portable communication apparatus according to an exemplary embodiment of the present invention.

FIG. 2 is a front view of the multimedia portable communication apparatus according to an exemplary embodiment of the present invention when the second housing is unfolded from the first housing and the third housing is slid away from the same.

FIG. 3 is a perspective view of the multimedia portable communication apparatus according to an exemplary embodiment of the present invention while the third housing is rotating.

FIG. 4 is a perspective view of the multimedia portable communication apparatus according to an exemplary embodiment of the present invention when the display unit is cradled at an angle and the first and second keyboards are unfolded.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

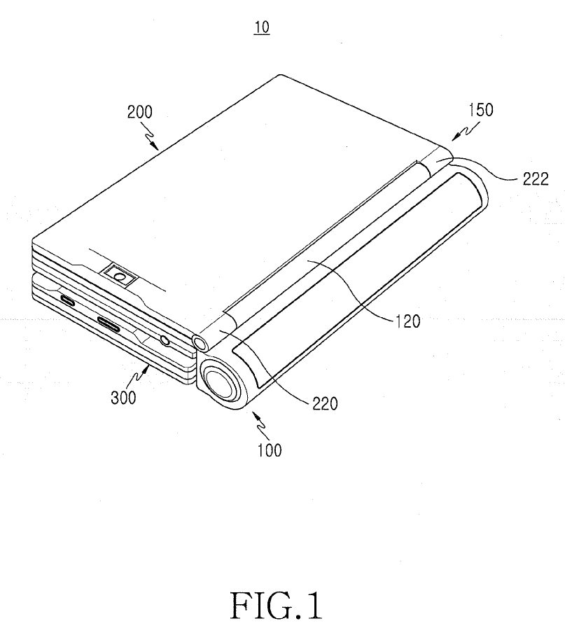

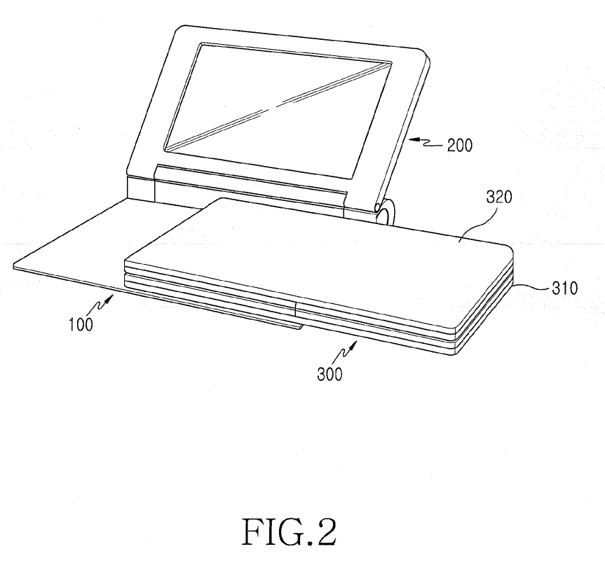

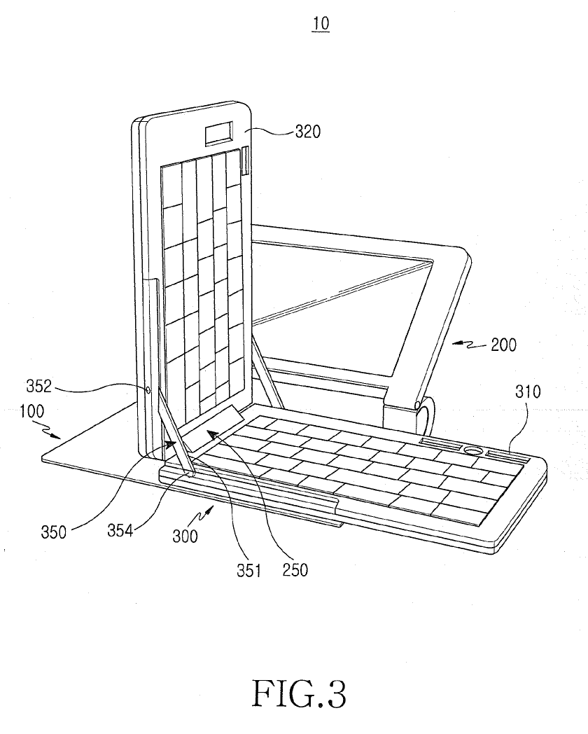

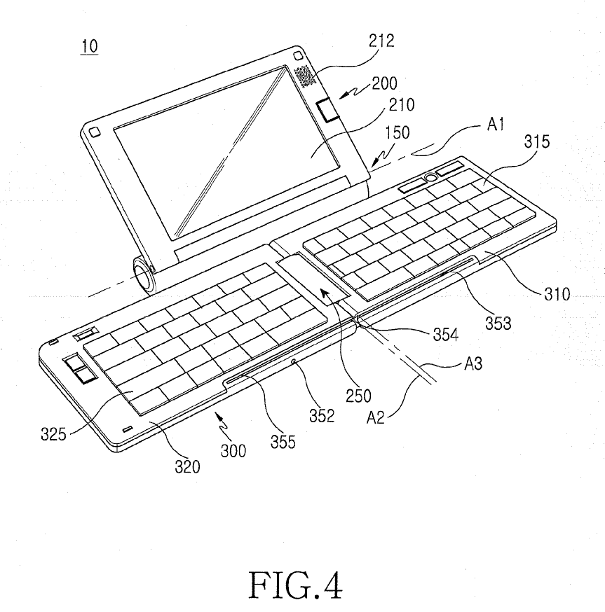

Referring to FIG. 1, FIG. 2, and FIG. 3, a portable communication apparatus 10 according to exemplary embodiments of the present invention is adapted for multimedia environments, i.e. it provides convenient data input operations and a wider display unit. Particularly, as shown in FIG. 4, the portable communication apparatus 10 may have a number of keyboards 315 and 325 and a display unit 210 configured in a folding type apparatus, which may improve data input/output environments while guaranteeing compactness. The portable communication apparatus according to exemplary embodiments of the present invention includes a first housing 100, a second housing 200, a third housing 300, a first hinge unit 150 to connect the first and second housings 100 and 200, and a sliding module (not shown) to connect the first and third housings 100 and 300. The second housing 200 is adapted to rotate in the transverse direction of the first housing 100 so as to fold onto/unfold from the first housing 100. The third housing 300 is adapted to slide along or rotate in the longitudinal direction of the first housing 100 while facing the first housing 100 so that it folds onto/unfolds from the first housing 100 to be positioned parallel to the longitudinal direction of the first and second housings 100 and 200. The first hinge unit 150 is connected between the first and second housings 100 and 200 to provide a first hinge axis A1. The first hinge unit 150 is adapted to semi-automatically fold/unfold the second housing 200 within a predetermined angular range relative to the first housing 100. The first hinge unit 150 includes a center hinge arm 120 (shown in FIG. 1) formed on the first housing 100, as well as a pair of side hinge arms 220 and 222 formed on the second housing 200 and coupled to the center hinge arm 120 via hinge modules (not shown).

As used herein, rotation in the transverse direction refers to rotation about the first hinge axis A1, which extends in the longitudinal direction of the first housing 100, and rotation in the longitudinal direction refers to rotation about a second or third hinge axis A2 or A3, which extend in the transverse direction of the first housing 100.

The second housing 200 includes a display unit 210 on its inner surface and a speaker device 212 adjacent to the display unit 210.

The third housing 300 includes at least one keyboard. Particularly, the third housing 300 may include a sliding housing 310 having a first keyboard 315 and a folding housing 320 having a second keyboard 325. The first and second keyboards 315 and 325 may be mounted on the first housing 100 as folding-type keyboards. The first keyboard 315 may be mounted on the inner surface of the sliding housing 310, and the second keyboard 325 may be mounted on the inner surface of the folding housing 320. Particularly, the folding housing 320 may be adapted to rotate in the longitudinal direction so as to fold onto/unfold from the sliding housing 310. The sliding and folding housings 310 and 320 may be rotatably connected to each other by a second hinge unit 250. Particularly, the second hinge unit 250 may rotatably connect the second keyboard 325 to the first keyboard 315. Together the first and second keyboards 315 and 325 may provide a QWERTY arrangement as shown in FIG. 4. In other words, the first and second keyboards 315 and 325 may be convenient to use in QWERTY-related modes.

The second hinge unit 250 rotatably connects the sliding and folding housings 310 and 320 using a dual hinge member, which provides second and third hinge axes A2 and A3. One end of the dual hinge member 250 is rotatably connected to the folding housing 320, and the other end is rotatably connected to the sliding housing 310.

FIG. 2 shows the second housing 200 unfolded from the first housing 100 (i.e. when it has moved away from the first housing 100), and FIG. 4 shows the folding housing 320 of the third housing 300 unfolded from the sliding housing 310 (i.e. when it has moved away from the sliding housing 310). It is also clear from FIG. 4 that, after unfolding from the sliding housing 310, the folding housing 320 may be positioned parallel to the second housing 200.

Referring to FIG. 3 and FIG. 4, a pair of auxiliary devices 350 may be positioned between the sliding and folding housings 310 and 320 to support the folding housing 320 when it is folded/unfolded. Particularly, the auxiliary devices 350 balance the force necessary to fold/unfold the folding housing 320. Each auxiliary device 350 includes a connector 351 and two guide openings 353 and 355. The connector 351 includes a stationary end 352 rotatably connected to the folding housing 320 and a movable end 354 rotatably connected to the sliding housing 310. The stationary end 352 may act as a stationary rotation shaft, and the movable end 354 may act as a moving rotation shaft moving along the guide opening 353.

The guide openings 353 and 355 are formed on the sliding and folding housings 310 and 320, respectively, to receive the connectors 351. The guide openings 353 and 355 may be twice as long as the connectors.

The relative positioning of the first and second hinge units 150 and 250 may be such that the second hinge unit 250 extends in a direction perpendicular to the first hinge unit 150 while being spaced apart from the first hinge unit 150. Particularly, the second and third hinge axes A2 and A3 may be parallel to each other, but may be perpendicular to and spaced apart from the first hinge axis A1.

The merits and effects of the exemplary embodiments, as disclosed in the present invention, and as so configured to operate above, will be described as follows.

The folding-type display unit is wide and may be adapted to be positioned in the horizontal direction at an angle, and the first and second keyboards may be adapted to slide and fold/unfold. Therefore, the inventive multimedia portable communication apparatus may enable a user to operate keys using both hands without increasing the overall size of the apparatus.

When the display unit is in the condition shown in FIG. 4, a user may conveniently watch displayed data, and the folding-type keyboard, which includes first and second keyboards, may enable the user to operate keys using both hands. As such, the user may be provided with a convenient user interface environment adapted for various modes of multimedia environments.

As described above, exemplary embodiments of the present invention provide a multimedia portable communication apparatus that may have an improved data input/output user interface in multimedia environments while guaranteeing compactness and portability. The apparatus is particularly convenient for portable Internet, QWERTY mode, DMB mode, etc. A user can input data using both hands and watch the display unit positioned in the horizontal direction. This may improve the user interface environment related to data input/output.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A multimedia portable communication apparatus, comprising:
a first housing;
a second housing comprising a display unit, the second housing being adapted to rotate in a transverse direction of the first housing so as to fold onto or unfold from the first housing;
a first hinge unit to rotatably connect the second housing to the first housing; and
a third housing comprising a keyboard, the third housing being adapted to slide along a longitudinal direction of the first housing while facing the first housing and to rotate in the longitudinal direction so that the third housing folds or unfolds to be parallel to a longitudinal direction of the second housing.

2. The apparatus of claim 1, wherein the third housing comprises:
a sliding housing comprising a first keyboard;
a folding housing comprising a second keyboard, the folding housing being adapted to rotate in the longitudinal direction so as to fold onto or unfold from the sliding housing; and
a second hinge unit to rotatably connect the folding housing to the sliding housing.

3. The apparatus of claim 2, wherein the folding housing is adapted to unfold from the sliding housing to be parallel to the second housing.

4. The apparatus of claim 2, further comprising an auxiliary device positioned between the sliding housing and the folding housing to support the folding housing.

5. The apparatus of claim 4, wherein the auxiliary device comprises:
a connector comprising a stationary end rotatably connected to the folding housing and a movable end rotatably connected to the sliding housing; and
guide openings to receive the connector on the folding housing and the sliding housing, respectively.

6. A multimedia portable communication apparatus, comprising:
a housing;
a display unit adapted to rotate in a first direction to fold onto or unfold from the housing;
a first hinge unit to rotatably connect the display unit to the housing; and
a folding-type keyboard adapted to slide in a second direction while facing the housing so that the keyboard is parallel to the display unit.

7. The apparatus of claim 6, wherein the display unit is adapted to be cradled on the folding-type keyboard at an angle by the first hinge unit.

8. The apparatus of claim 6, wherein the folding-type keyboard comprises:
a first keyboard adapted to slide in a third direction while facing the housing; and
a second keyboard rotatably connected to the first keyboard by a second hinge unit spaced apart from the first hinge unit.

9. The apparatus of claim 8, the folding-type keyboard comprises an auxiliary device to support the folding-type keyboard.

10. The apparatus of claim 9, wherein the auxiliary device comprises:
a connector comprising a stationary end rotatably connected to the first keyboard and a movable end rotatably connected to the second keyboard; and
guide openings to receive the connector on the first keyboard and the second keyboard, respectively.

11. The apparatus of claim 6, wherein the first direction is a transverse direction and the second direction is a longitudinal direction.

12. The apparatus of claim 8, wherein the third direction is a longitudinal direction.
